(19) United States
(12) Patent Application Publication
(10) Pub. No.: US 2024/0135266 A1
(43) Pub. Date: Apr. 25, 2024

(54) MOVING OBJECT UTILIZATION SYSTEM AND MOVING OBJECT UTILIZATION METHOD

(71) Applicant: NAGASE & CO., LTD., Osaka (JP)

(72) Inventors: Kenro SHIBATA, Tokyo (JP); Tsutomu KIKUCHI, Miyagi (JP)

(73) Assignee: NAGASE & CO., LTD., Osaka (JP)

(21) Appl. No.: 18/271,763

(22) PCT Filed: Dec. 28, 2021
(86) PCT No.: PCT/JP2021/049007

§ 371 Date: Jul. 10, 2023

(30) Foreign Application Priority Data
Jan. 13, 2021 (JP) 2021- 003799

(51) Int. Cl. G06Q 10/02; G06Q 30/0645; G06Q 50/43; G07C 5/00

(52) U.S. Cl. CPC G06Q 10/02; G06Q 30/0645; G06Q 50/43; G07C 5/008

(57) ABSTRACT

An object of the present invention is to provide a moving object utilization system and a moving object utilization method capable of grasping whether a moving object to be used by a user is appropriately used or has appropriately been used.

A moving object utilization system comprising a plurality of user terminals operated by a plurality of respective users; and a server device capable of establishing communication connection with the user terminals, the moving object utilization system providing a service for the plurality of users to use a moving object in turn, wherein the server device includes an information transmitter that transmits user information on one user who is using a moving object and/or using state information on a using state of a moving object to another user terminal operated by another user different from the one user.

### TECHNICAL FIELD

The present invention relates to moving object utilization system and moving object utilization method providing a service for a plurality of users to use a moving object in turn.

### BACKGROUND ART

Conventionally, services for renting or sharing a vehicle such as an automobile has been provided. These services have an advantage that the vehicle can be used at a desired timing even if the vehicle is not owned.

In these car rental and car sharing services, since a vehicle is used by an unspecified user, in a case where the user who has used the vehicle earlier contaminates the interior of the vehicle without maintaining a clean state, the next user cannot comfortably use the same vehicle. In order to solve such a problem, for example, there is disclosed an information processing system that acquires intensity of an odor in an interior of a vehicle and outputs information for requesting cleaning of the vehicle in a case where the intensity of the odor is equal to or greater than a threshold (see, for example, Patent Literature 1).

However, if the cleaning of the inside of the vehicle is performed at an appropriate timing in this manner, although the opportunity that the user feels uncomfortable can be reduced to some extent, the user can use the car rental or car sharing service without a sense of anxiety as long as the user can grasp whether the vehicle scheduled to be used is appropriately used. However, until now, there has been no means for grasping whether a vehicle scheduled to be used has been appropriately used.

### CITATION LIST

### Patent Literature

Patent Literature 1: JP 2020-189599 A

### SUMMARY OF INVENTION

### Technical Problem

The present invention has been made to solve such a problem. That is, an object of the present invention is to provide a moving object utilization system and a moving object utilization method capable of grasping whether a moving object to be used by a user is appropriately used or has appropriately been used.

### Solution to Problem

The problem of the present invention can be achieved by the following;
[1] A moving object utilization system comprising:
   a plurality of user terminals operated by a plurality of respective users; and a server device capable of establishing communication connection with the user terminals, the moving object utilization system providing a service for the plurality of users to use a moving object in turn,
   wherein the server device includes an information transmitter that transmits user information on one user who is using the moving object or has used the moving object and/or using state information on a using state of the moving object to another user terminal operated by another user different from the one user.
[2] The moving object utilization system according to [1] comprising a use reservation executer that executes use reservation of the moving object by an operation of each of the user terminals.
[3] The moving object utilization system according to claim 1 or 2,
   wherein the moving object includes a device capable of acquiring information on the moving object, surroundings of the moving object, and/or a state in the moving object, and
   the using state information is information acquired by the device.
[4] The moving object utilization system according to [3], wherein when the one user uses the moving object and information acquired by the device satisfies a predetermined condition, the information transmitter performs transmission to the another user terminal operated by the another user who has made a use reservation of the moving object.
[5] The moving object utilization system according to [3] or [4], wherein the server device includes a use reservation stopper that stops the use reservation of the moving object when the one user uses the moving object and the information acquired by the device satisfies a predetermined condition.
[6] The moving object utilization system according to any one of [3] to [5], wherein the another user terminal operated by the another user includes a moving object displayer that displays the moving object in a mode in which the moving object can be understood as satisfying a predetermined condition when the one user uses the moving object and the information acquired by the device satisfies the predetermined condition.
[7] A moving object utilization method executed in a moving object utilization system including a plurality of user terminals operated by a plurality of respective users and a server device capable of establishing communication connection with the user terminals, the moving object utilization system providing a service for the plurality of users to use a moving object in turn, the moving object utilization method comprising:
   an information transmission step of transmitting, by the server device, user information on one user who is using or has used the moving object and/or using state information on a using state of the moving object to another user terminal operated by another user different from the one user.
[8] A server device in a moving object utilization system including: a plurality of user terminals operated by a plurality of respective users; and the server device capable of establishing communication connection with the user terminals, the moving object utilization system providing a service for the plurality of users to use a moving object in turn,
   wherein the server device includes an information transmitter that transmits user information on one user who is using the moving object or has used the moving object and/or using state information on a using state of the moving object to another user terminal operated by another user different from the one user.
[9] A user terminal in a moving object utilization system including: a plurality of user terminals operated by a plurality of respective users; and a server device capable of establishing communication connection with the user terminals, the moving object utilization system providing a service for the plurality of users to use a moving object in turn,
   wherein the user terminal includes an information displayer that displays user information on another user who is using the moving object or has used the moving object and/or using state information on a using state of the moving object.
[10] A program executed in a computer device capable of establishing communication connection with a plurality of user terminals operated by a plurality of respective users,
   the program causing the computer device to function as a determiner that determines whether or not user information on one user who is using a moving object or who has used the moving object and/or using state information on a using state of the moving object satisfy a predetermined condition for transmission to another user terminal operated by another user different from the one user.
[11] The program according to [10], wherein the moving object includes a device capable of acquiring information on the moving object, surroundings of the moving object, and/or a state in the moving object, and
   the using state information is information acquired by the device.
[12] A computer device capable of establishing communication connection with a plurality of user terminals operated by a plurality of respective users, the computer device comprising:
   a determiner that determines whether or not user information on one user who is using a moving object or who has used the moving object and/or using state information on a using state of the moving object satisfy a predetermined condition for transmission to another user terminal operated by another user different from the one user.

### Advantageous Effects of Invention

According to the present invention, it is an object to provide a moving object utilization system and a moving object utilization method capable of grasping whether a moving object to be used by a user is appropriately used or has appropriately been used.

### BRIEF DESCRIPTION OF DRAWINGS

FIG. 1 is a block diagram illustrating a configuration of the moving object utilization system according to an embodiment of the present invention.

FIG. 2 is a block diagram illustrating a configuration of the user terminal according to the embodiment of the present invention.

FIG. 3 is a block diagram illustrating a configuration of the server device according to the embodiment of the present invention.

FIG. 4 is a flowchart illustrating reservation processing according to the embodiment of the present invention.

FIG. 5 is a diagram illustrating a vehicle management table according to the embodiment of the present invention.

FIG. 6 is a flowchart illustrating vehicle monitoring processing according to the embodiment of the present invention.

### DESCRIPTION OF EMBODIMENTS

Hereinafter, an embodiment of the present invention will be described, but the present invention is not limited to the following embodiment unless it is contrary to the gist of the present invention. The moving object utilization system of the present invention can be applied not only to vehicles such as automobiles, but also to general conveyances on which people can board including: aircrafts such as drones, helicopters, airships, gliders, and jet planes; ships such as ferries and cargo ships; and vehicles used in public transportation such as buses and trains. That is, the moving object in the present invention is a concept including not only a vehicle but also the above-described aircraft and ship.

Hereinafter, a case where a user uses a car sharing service will be mainly described, but the moving object utilization system of the present invention can be applied not only to the car sharing service but also to a car rental service and a car lease service. Note that the car sharing service refers to a service for sharing a vehicle such as an automobile between users, and the car rental service refers to a service for renting a vehicle such as an automobile from an owner. In addition, the car lease service refers to a service in which a leasing company purchases a vehicle on behalf of a user, and the user continuously pays a lease fee to the leasing company, so that the purchased vehicle can be used. Note that even in a case where the moving object is not a vehicle but is an aircraft or a ship, the moving object utilization system of the present invention can be applied to each of a sharing service, a rental service, and a lease service.

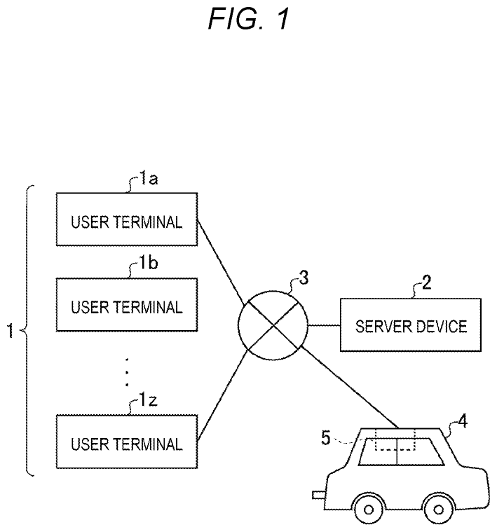

FIG. 1 is a block diagram illustrating a configuration of the moving object utilization system according to an embodiment of the present invention. As illustrated, the moving object utilization system includes user terminals 1a to 1z, a server device 2, and a communication network 3. For example, the user terminals 1a to 1z are owned and operated by a plurality of respective users who intend to use a car sharing service. The user terminal 1 can establish communication connection with the server device 2 via the communication network 3.

A vehicle 4 to be subjected to car sharing includes an information acquisition device 5, and the vehicle 4 can establish communication connection with the server device 2. The information acquired by the information acquisition device 5 is transmitted to the server device 2 by wireless communication. The information acquired by the information acquisition device 5 is processed inside the vehicle body (edge), and only feature amount information may be uploaded to the server device 2 side. These pieces of information may be encrypted from the viewpoint of security. Furthermore, it is also conceivable that threshold determination is performed on the edge side on the basis of the feature amount information processed by the edge, and only information such as a quality result is uploaded. As a result, since the information for specifying a user is not uploaded, the user can use the vehicle without worrying about privacy. The threshold necessary for each determination can be rewritten via a cloud or using a remote communication unit. At the same time, when it is determined that there is an abnormality, a manager of the moving object acquires a vehicle interior video only at the moment (short time), and the manager can grasp the detailed state. By acquiring this information, the manager can more accurately determine what is actually occurring.

The user terminal 1 is not particularly limited as long as it is a computer device having a display screen and an input unit. The user terminal 1 may be a stationary type or a portable type that can be carried by a user when the user moves. Examples of the user terminal 1 include a conventional mobile phone, a tablet terminal, a smartphone, a desktop/notebook personal computer, and the like.

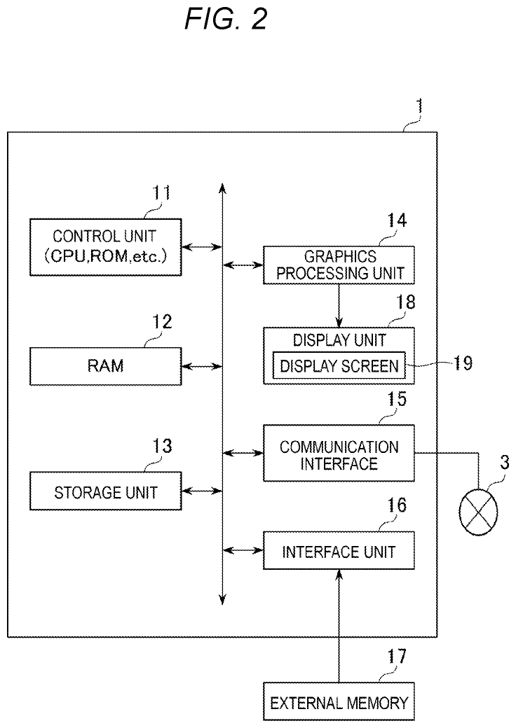

FIG. 2 is a block diagram illustrating a configuration of the user terminal according to the embodiment of the present invention. The user terminal 1 includes a control unit 11, a RAM 12, a storage unit 13, a graphics processing unit 14, a communication interface 15, and an interface unit 16, which are connected by an internal bus.

The control unit 11 includes a CPU and a ROM. The control unit 11 executes a program stored in the storage unit 13 and controls the user terminal 1. The RAM 12 is a work area of the control unit 11. The storage unit 13 is a storage area for storing a program and data. The control unit 11 reads a program and data from the RAM 12 and performs processing. The control unit 11 outputs a drawing command to the graphics processing unit 14 by processing the program and data loaded in the RAM 12.

The graphics processing unit 14 is connected to a display unit 18. The display unit 18 has a display screen 19. When the control unit 11 outputs the drawing command to the graphics processing unit 14, the graphics processing unit 14 outputs a video signal for displaying an image on the display screen 19. Here, the display unit 18 may be a touch panel including a touch sensor. The touch panel of the display unit 18 functions as an input unit.

The communication interface 15 can be connected to the communication network 3 wirelessly or by wire, and can transmit and receive data to and from the server device 2 via the communication network 3. Data received via the communication interface 15 is loaded into the RAM 12, and arithmetic processing is performed by the control unit 11. An external memory 17 (for example, a secure digital (SD) card or the like) is connected to the interface unit 16.

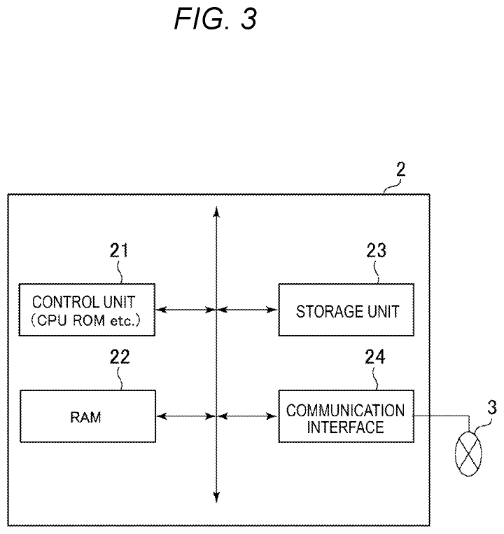

FIG. 3 is a block diagram illustrating a configuration of the server device according to the embodiment of the present invention. The server device 2 includes at least a control unit 21, a RAM 22, a storage unit 23, and a communication interface 24, which are connected by an internal bus.

The control unit 21 includes a CPU and a ROM, executes a program stored in the storage unit 23, and controls the server device 2. In addition, the control unit 21 includes an internal timer that clocks time. The RAM 22 is a work area of the control unit 21. The storage unit 23 is a storage area for storing a program and data. The control unit 21 reads a program and data from the RAM 12, and performs program execution processing on the basis of information or the like received from the user terminal 1.

In addition, the vehicle 4 is not particularly limited as long as it is a conveyance that can move on the land, but preferably has wheels. The vehicle 4 is a concept including not only a bicycle, a motorized bicycle, a motorcycle, an automobile, and the like, for example, but also vehicles used for special purposes including: a construction vehicle used for construction applications such as a dump car and a bulldozer; an industrial vehicle used for load conveyance such as a forklift; and an agricultural vehicle used for agriculture such as a tractor.

The information acquisition device 5 is not particularly limited as long as it can acquire information on the vehicle 4, the surroundings of the vehicle 4, or the inside (interior) of the vehicle 4. Here, the information on the vehicle 4 is information on the whole or a part of the vehicle 4, and is a concept including, for example, information on a tire, an engine, or the vicinity thereof of the vehicle 4. The information on the surroundings of the vehicle 4 is information on the outside of the vehicle 4.

Examples of the information acquisition device 5 include a driver monitoring system (DMS) and an on-vehicle device. By the DMS, it is possible to detect whether or not a driver is in an appropriate state, for example, whether or not the driver is in a dozing state, whether or not the driver is yawning, whether or not the driver is distracted driving, and the like. The on-vehicle device can acquire position information by a GPS or the like and acceleration information by an acceleration sensor.

In addition, examples of the information acquisition device 5 include an odor sensor, an alcohol checker, a body temperature sensor, and the like. The odor sensor can detect air contamination, an amount of carbon dioxide in the vehicle, and the like. Furthermore, the alcohol checker can detect the alcohol concentration contained in the exhalation of a user.

Examples of the information acquisition device 5 include an imaging device capable of capturing a still image or a moving image. It is possible to detect whether or not there is dirt, whether or not there is something left behind, whether or not there is an action such as vomiting, whether or not an infant or the like is left on the vehicle 4, and the like by a difference between images before and during or after use of the vehicle 4, or by utilizing AI or the like. In addition, it is also possible to measure and acquire temperature, humidity, atmospheric pressure, and the like in the vehicle using the information acquisition device 5.

Furthermore, as the information acquisition device 5, it is also possible to measure and acquire the air pressure and the temperature inside a tire of the vehicle 4 by a tire sensor installed on the tire (or in the vicinity of the tire). It is also possible to estimate the presence or absence of puncture or the like on the basis of information acquired from the tire sensor. In addition, as the information acquisition device 5, it is also possible to measure and acquire the rotation speed and the temperature of an engine of the vehicle 4 by a sensor installed in the engine (or in the vicinity of the engine).

In addition, examples of the information acquisition device 5 include a drive recorder. When a large impact is applied to the vehicle, such as when the vehicle collides with some obstacle and suddenly stops, the drive recorder can acquire images and sounds outside the vehicle (in front of or behind the vehicle) in a period of several 10 seconds before and after the impact.

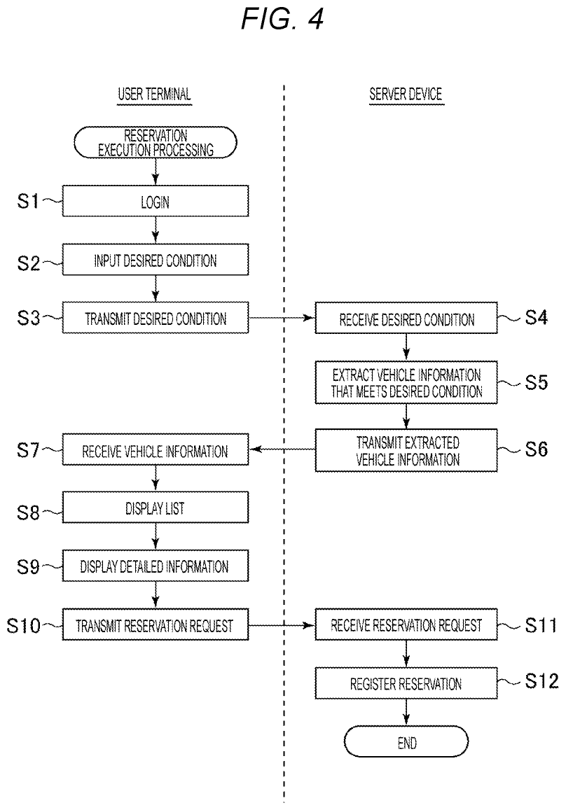

Next, reservation processing will be described. FIG. 4 is a flowchart illustrating reservation processing in the moving object utilization system according to the embodiment of the present invention. A user who wishes to use a car sharing service operates the user terminal 1 to access a predetermined website (that is, the server device 2 is accessed via a browser). A user ID and a password are registered for each user, and the user logs in to the moving object utilization system on the website by inputting the user ID and the password to the user terminal 1 (step S1).

Next, the user operates the user terminal 1 and inputs a desired condition when using the car sharing service (step S2). Examples of the desired condition include a date and time at which sharing is desired, a parking place of the vehicle 4 that is shared, a budget, and/or a vehicle type of the vehicle 4. The input desired condition is transmitted to the server device 2 (step S3) and received by the server device 2 (step S4).

In the server device 2, the vehicle 4 that meets the desired condition is specified (step S5). In step S5, when the vehicle 4 that meets the desired condition is specified, the vehicle 4 is identified by referring to a vehicle management table to be described later. Note that, in the server device 2, only the vehicle 4 that meets the desired condition can be specified and displayed on the display screen 19 of the user terminal 1, but in the server device 2, the vehicle 4 that does not meet the desired condition can also be specified and simultaneously displayed on the display screen 19. In this case, the information on the vehicle 4 that meets the desired condition can be preferentially displayed on the upper part of the display screen, or the information on the vehicle 4 that does not meet the desired condition can be displayed in a different color.

When the vehicle 4 that meets the desired condition is specified in step S5, the vehicle 4 that satisfies the predetermined condition can be excluded from the specific target of the vehicle 4 in step S5. The determination as to whether or not the predetermined condition is satisfied may be executed in advance in the server device 2 or may be executed when the vehicle 4 is specified in step S5. Furthermore, a result of the determination is registered in the vehicle management table to be described later.

Examples of the determination as to whether or not the vehicle 4 satisfies a predetermined condition include determination as to whether or not user information on a user who is using the vehicle 4 or who has used the vehicle 4 in the past satisfies a predetermined condition. The predetermined condition in this case can be designed as appropriate, as long as it is a condition on the user, and examples thereof include that the user or a passenger thereof is a smoker, and that the user has suffered from a predetermined infectious disease when using the vehicle 4.

Examples of the determination as to whether or not the vehicle 4 satisfies a predetermined condition include determination as to whether or not the using state information on the using state of the vehicle 4 satisfies a predetermined condition. As the predetermined condition in this case, the same condition as the predetermined condition in step S25 to be described later can be adopted.

Then, vehicle information on the specified vehicle 4 is transmitted from the server device 2 to the user terminal 1 (step S6). The vehicle information transmitted to the user terminal 1 can be acquired from the vehicle management table to be described later.

Note that, in step S5, in a case where there is no vehicle 4 that meets the desired condition input by the user and that is available at the date and time when the user desires sharing, a notification indicating that there is no available vehicle 4 is transmitted from the server device 2 to the user terminal 1, and the notification is displayed on the display screen 19. In this case, the user operates the user terminal 1 to input a desired condition again.

When the vehicle information is received by the user terminal 1 (step S7), on the display screen 19 of the user terminal 1, a list of simple information such as the vehicle type, the number of people who can be on board, the cost, and the appearance image of the vehicle corresponding to a plurality of pieces of vehicle information extracted in step S5 is displayed (step S8). The simple information displayed here is acquired from the vehicle management table to be described later.

In step S8, the list of the plurality of pieces of vehicle information extracted in step S5 is displayed, but the vehicle 4 satisfying the above-described predetermined condition can also be included in the list. The vehicle 4 satisfying the predetermined condition can be displayed in a mode in which the vehicle 4 can be understood as satisfying the predetermined condition by changing a color of text or a background used for display or displaying a specific symbol so that the vehicle 4 can be distinguished from the vehicle 4 not satisfying the predetermined condition.

Next, when the user operates the user terminal 1 to select a vehicle 4 to be checked for details from among the plurality of vehicles 4, detailed information of the selected vehicle 4 is displayed on the display screen 19 (step S9). The detailed information displayed here can also be acquired from the vehicle management table to be described later.

The displayed detailed information includes user information on a user who has used the vehicle 4 in the past and/or using state information on a using state of the vehicle. The past history displayed in the detailed information may be only the user information on the preceding user and/or the use information on the using state thereof, or may be the user information on the user and/or the use information on the using state thereof in the predetermined number of times of use immediately before. These pieces of information are stored in the vehicle management table to be described later, and these pieces of information are extracted from the vehicle management table in step S5, and are transmitted from the server device 2 to the user terminal 1 in step S6.

Here, the user information on a user is, for example, information on an attribute of the user. The information on an attribute of the user includes age and sex, and also includes passenger information such as age, sex, and the number of passengers.

Examples of the using state information on the using state of the vehicle 4 by the user include information indicating whether or not there is a failure or a travel distance of the vehicle 4 at the time of using the vehicle 4, and whether or not the user has appropriately used the vehicle 4. For example, the information indicating whether or not the user has appropriately used the vehicle 4 includes information indicating that the user has been drunk driving, information indicating that the user has been sick and has thrown up in the vehicle, and the like. Furthermore, the using state information on the using state of the vehicle 4 by the user may include not only using state information by the user who is currently using the vehicle 4 or the user who has used the vehicle 4 immediately before, but also using state information accumulated by usage of the vehicle 4 by a plurality of users in the past.

The using state information on the using state of the vehicle 4 includes, for example, information on the maintenance state and history of the vehicle 4. Examples of the information on the maintenance state and history of the vehicle 4 include information on a history of replacement of engine oil, other consumables, parts, and the like, and a history of a vehicle inspection.

In step S9, after the detailed information of the vehicle 4 is introduced on the display screen 19, when the user wishes to confirm the detailed information of another vehicle, the user can operate the user terminal 1 to return to the screen displaying the list of the simple information in step S8, and select another desired vehicle to confirm the detailed information.

In step S9, the user checks the detailed information displayed on the display screen, and presses a reservation button if the user wishes to reserve the vehicle 4. When the reservation button is pressed, a reservation request is transmitted from the user terminal 1 to the server device 2 for the vehicle 4 corresponding to the displayed detailed information (step S10).

When the server device 2 receives the reservation request (step S11), the reservation date and time is registered in association with the corresponding vehicle 4 in the vehicle management table to be described later (step S12). By steps S1 to S12, the reservation processing ends. The reserved vehicle 4 cannot be reserved or used by other users at the reserved date and time.

Note that, at the time of the reservation request in step S10, not only the age and sex of the user but also the number of passengers and the age, sex, and the like of the passengers can be requested to be input. The input user and passenger information can also be stored as user information in association with a vehicle ID in the vehicle management table to be described later.

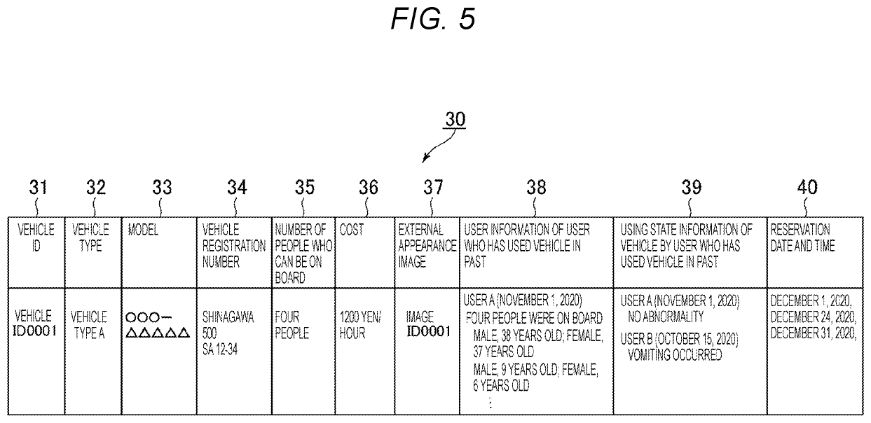

FIG. 5 is a diagram illustrating a vehicle management table according to the embodiment of the present invention. A vehicle management table 30 is set in the server device 2. The vehicle management table 30 stores a vehicle type 32, a model 33, a vehicle registration number 34, a number of people who can be on board 35, cost 36, an external appearance image 37, user information of a user who has used the vehicle in the past 38, using state information of the vehicle by the user who has used the vehicle in the past 39, reservation date and time 40, and the like in association with a vehicle ID 31, but may store other information.

Incidentally, a card with an integrated circuit (IC) chip is distributed to a user when the user is registered as a member of the car sharing service. The user goes to the parking lot where the reserved vehicle 4 is parked at the reserved time, and holds the card over a reading unit of a locking device provided to the vehicle 4, so that a door of the vehicle 4 can be unlocked and the vehicle 4 can be used. Note that, although the card with the IC chip is used for unlocking, the unlocking method is not particularly limited. For example, the doors of the vehicle 4 may be unlocked using face authentication, other biometric authentication, a QR code (registered trademark), and the like.

When the reservation is made in step S12, authentication information that enables only the card owned by the user who has reserved the vehicle 4 to be authenticated only within the reserved time is transmitted to the locking device of the vehicle 4. In the locking device, the reading unit authenticates the card information on the basis of the received authentication information. Even if the user brings the card close to the locking device outside the reserved time of the vehicle 4, unlocking is not performed.

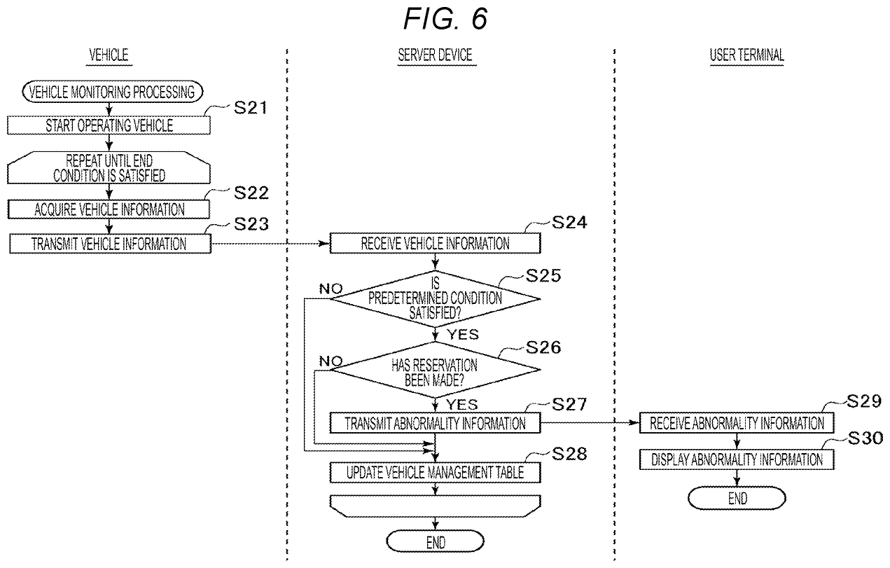

Next, vehicle monitoring processing will be described. FIG. 6 is a flowchart illustrating vehicle monitoring processing according to the embodiment of the present invention.

The user can unlock a door of the vehicle 4 by holding the card with the IC chip over a reading unit of a locking device installed to the vehicle. The user can start using the vehicle 4 by unlocking the door of the vehicle 4, getting on the vehicle 4, and then operating the engine (step S21). When the use of the vehicle 4 is started, the information acquisition device 5 provided in the vehicle 4 acquires information on the vehicle 4, the surroundings of the vehicle 4, or the interior of the vehicle (displayed as “vehicle information” in FIG. 6) (step S22). Note that the processing of steps S22 to S28 is repeatedly executed until the use of the vehicle ends (for example, until the time available for use by the user elapses or until the vehicle 4 returns to a predetermined parking lot where the vehicle 4 was parked before use).

The information acquired by the information acquisition device 5 is transmitted to the server device 2 by wireless communication substantially in real time or at regular intervals (step S23). Note that transmission of information from the information acquisition device 5 to the server device 2 may be executed via a relay device provided in the vehicle 4.

When the information on the vehicle 4, the surroundings of the vehicle 4, or the interior of the vehicle acquired by the information acquisition device 5 is received (step S24), it is determined whether a predetermined condition is satisfied on the basis of the received information (step S25). The predetermined condition is a condition indicating that the user who is currently using the vehicle is not appropriately using it, that is, the vehicle is in an abnormal state. As a result of the determination, when the predetermined condition is satisfied (YES in step S25), whether the corresponding vehicle 4 is reserved by another user or the like after the user who is using the vehicle 4 at this time is determined (step S26).

In a case where there is a reservation by another user or the like (YES in step S26), abnormality information indicating that the predetermined condition is satisfied is transmitted to the user terminal 1 of the user who has made the reservation (step S27). The user terminal 1 of the user who has made the reservation may be the same user as the user who is using the vehicle 4, or may be another user. In many cases, the user terminal 1 of another user different from the user using the vehicle 4 is notified that the predetermined condition is satisfied.

After the abnormality information is transmitted to the user terminal 1 in step S27, the vehicle management table 30 is updated on the basis of the information on the vehicle 4, the surroundings of the vehicle 4, or the interior of the vehicle, and the abnormality information received in step S24 (step S28). The information on the vehicle 4, the surroundings of the vehicle 4, or the interior of the vehicle, and the abnormality information are stored together with the use date and time by the user in the user information of the user who has used the vehicle in the past 38 and the using state information of the vehicle by the user who has used the vehicle in the past 39 in association with the vehicle ID. These pieces of information are used as materials for determining whether or not another user makes a reservation at a later date or in a time zone after being updated even on the current day.

In step S28, when the vehicle 4 is in an abnormal state, it may be registered in the vehicle management table 30 of the server device 2 that the use and the reservation for use of the vehicle 4 are in a stopped state. In this case, whether or not to register the fact that the use and the reservation for use are in the stopped state in the vehicle management table 30 may be determined in the server device 2 according to a predetermined criterion determined in advance for the abnormal state. In this way, even if an abnormal state occurs, it is possible to stop only when the use and the reservation for use should be stopped. Furthermore, as will be described later, whether or not to stop the use and the reservation for use of the vehicle 4 can be individually determined by an operator of the moving object utilization system, and the vehicle management table 30 can be manually updated.

When the abnormality information is transmitted in step S27, the abnormality information is received by the user terminal 1 (step S29) and displayed on the display screen 19 of the user terminal 1 (step S30). Note that, in a case where the vehicle 4 in the abnormal state is reserved by a plurality of other users, the abnormality information may be transmitted to the user terminals 1 of the plurality of other users, or the abnormality information may be transmitted only to the user terminal 1 of the user who is scheduled to use the vehicle 4 next to the user at the present time.

Note that the abnormality information can be automatically transmitted to the user terminal 1 in step S27, but the abnormality information may be transmitted to the user terminal 1 in step S27 only when the operator of the moving object utilization system individually analyzes the abnormality information and determines that the transmission of the abnormality information is necessary. When it is determined in step S25 that the condition indicating the abnormal state is satisfied, the operator is notified of the fact. The operator determines whether or not to transmit the abnormal state in light of a predetermined determination criterion or threshold, and executes an operation for transmitting the abnormal state to the server device 2 when transmitting the abnormal state. In this way, it is possible to select only the abnormality information that needs to be notified to the user and notify the user of the abnormality information.

In addition, in a case where it is determined in step S25 that the condition indicating the abnormal state is satisfied, the operator of the moving object utilization system individually analyzes the abnormality information, and can take a measure of prohibiting use and reservation for use so as not to lend the vehicle 4. The operator of the moving object utilization system manually updates the vehicle management table 30 of the server device 2, and updates that the use and the reservation for use of the vehicle 4 are in the stop state. Therefore, the moving object utilization system of the present invention can provide the user with a sense of security of using the vehicle while securing the safety of the user when using the vehicle.

Furthermore, in the moving object utilization system of the present invention, the information acquired by the information acquisition device 5 is transmitted to the server device 2, and these pieces of information are accumulated in the server device 2. Therefore, the moving object utilization system can be effectively used for maintenance of the vehicle 4. By sequentially grasping the state of the vehicle 4, maintenance can be performed at necessary timing when necessary. For example, occurrence of tire puncture or the like can be predicted by a tire sensor or the like, and danger can be avoided.

Here, the predetermined condition is not particularly limited as long as it can be a condition indicating that the user who is currently using the vehicle is not appropriately using the vehicle. Examples of the condition indicating that the user is not appropriately using the vehicle include detection that the driver is in a dozing state by the DMS, detection that an odor component in the vehicle becomes equal to or greater than a threshold due to smoking or the like by the odor sensor, detection that an alcohol concentration included in exhalation of the user becomes equal to or greater than a threshold by the alcohol checker, and detection that a body temperature of a passenger becomes equal to or greater than a threshold. In addition, as a condition indicating that the user is not appropriately using the vehicle, occurrence of contamination in the vehicle is detected by image analysis, occurrence of an action such as vomiting is detected, and the like can be cited.

Therefore, in step S30, the display screen 19 of the user terminal 1 of the user who has made a reservation for the vehicle 4 displays information indicating that the user who has previously used the vehicle 4 has not appropriately used the vehicle and that there has been smoking, drunk driving, dirt inside the vehicle, vomiting, and the like. The user who has reserved the vehicle 4 can cancel the reservation by knowing these pieces of information before the reservation. The user can also reserve another vehicle 4 by knowing these pieces of information at an early stage.

The threshold on the data as to whether the predetermined condition is satisfied can be determined by the operator as appropriate after a large number of demonstration experiments and actual operations are repeated and the voices of users are reflected. In addition, it is also possible to cause artificial intelligence (AI) to perform machine learning using these demonstration experiment, actual operations, user's voices, and the like as teacher data, to determine whether or not a predetermined condition is satisfied by the AI and to specify an appropriate threshold value.

In step S25, it is determined whether or not the predetermined condition is satisfied on the basis of the received information. In a case where it is determined that the predetermined condition is not satisfied (NO in step S25), the vehicle management table 30 is updated as necessary on the basis of the information on the vehicle, the surroundings of the vehicle 4, or the interior of the vehicle received in step S24 (step S28).

In addition, in step S26, it is determined whether a reservation for the vehicle 4 has been made, but in a case where no reservation has been made by another user or the like after the user using the vehicle 4 (NO in step S26), the vehicle management table 30 is updated on the basis of the information on the vehicle, the surroundings of the vehicle 4, or the interior of the vehicle, and the abnormality information received in step S24 (step S28).

The processing of steps S22 to S28 is repeatedly executed until the vehicle 4 returns to the original parking lot and the use by the user ends. When the use of the vehicle 4 ends, the vehicle monitoring processing ends.

The predetermined condition in the moving object utilization system of the present invention may be determined by the operator of the moving object utilization system, and the determined condition may be registered in the server device 2. Alternatively, a user himself/herself may determine a condition, operate the user terminal 1 to input the condition, and transmit the input condition to the server device 2, so that the condition determined by the user can be registered in the server device 2.

In the embodiment described above, it has been described that the moving object utilization system of the present invention is mainly applied to a car sharing service, but the moving object utilization system can also be preferably used for a car lease service. The car lease is different from car sharing or the like in that the same user uses the same vehicle for a long period of time, but by using this moving object utilization system, a leasing company can grasp the deterioration state of the vehicle body. The leasing company can evaluate the vehicle using the information obtained from the moving object utilization system, and can present an appropriate resale condition for resale to the user when the vehicle is returned from the user.

According to the present invention, the user information on one user who is using the moving object and/or the using state information on the using state of the moving object of the one user can be transmitted to another user terminal operated by another user different from the one user and browsed on the other user terminal, and thus, the other user can grasp whether the moving object reserved by the user or the moving object considered to be reserved is appropriately used or has appropriately been used. Note that, here, one user is a concept representing a user who is currently using the moving object or has already used the moving object, and another user is not yet using the moving object and has reserved use of the moving object or is considering reservation.

Furthermore, according to the present invention, since the use reservation of the moving object can be executed by the operation of the user terminal, another user can reserve the use of the moving object after grasping whether the moving object desired to be used by the user is appropriately used or has appropriately been used.

Furthermore, according to the present invention, the moving object includes a device capable of acquiring information on the state of the moving object and/or the inside of the moving object, and the information on the using state of the moving object is the information acquired by the device. Therefore, another user can accurately grasp the information on the using state of the moving object and/or the inside of the moving object.

Furthermore, according to the present invention, in a case where one user uses the moving object and information acquired by the device satisfies a predetermined condition, by transmitting using state information on a using state of the moving object of the user to another user terminal operated by another user who has made a use reservation of the moving object, the other user can recognize that the moving object is not appropriately used even after making the reservation. The other user can cancel the use reservation of the moving object by receiving the notification of the using state information on the using state of the moving object of the user.

### REFERENCE SIGNS LIST

1 User terminal
2 Server device
3 Communication network
4 Vehicle
5 Information acquisition device
11 Control unit
12 RAM
13 Storage unit
14 Graphics processing unit
15 Communication interface
16 Interface unit
17 External memory
18 Display unit
19 Display screen
21 Control unit
22 RAM
23 Storage unit
24 Communication interface
30 Vehicle management table
31 Vehicle ID
32 Vehicle type
33 Model
34 Vehicle registration number
35 Number of people who can be on board
36 Cost
37 External appearance image
38 User information of a user who has used a vehicle in the past
39 Using state information of a vehicle by a user who has used the vehicle in the past
40 Reservation date and time

1. A moving object utilization system comprising:
a plurality of user terminals operated by a plurality of respective users; and a server device capable of establishing communication connection with the user terminals, the moving object utilization system providing a service for the plurality of users to use a moving object in turn,
wherein the server device includes an information transmitter that transmits user information on one user who is using the moving object or has used the moving object and/or using state information on a using state of the moving object to another user terminal operated by another user different from the one user.

2. The moving object utilization system according to claim 1 comprising a use reservation executer that executes use reservation of the moving object by an operation of each of the user terminals.

3. The moving object utilization system according to claim 1,
wherein the moving object includes a device capable of acquiring information on the moving object, surroundings of the moving object, and/or a state in the moving object, and
the using state information is information acquired by the device.

4. The moving object utilization system according to claim 3, wherein when the one user uses the moving object and information acquired by the device satisfies a predetermined condition, the information transmitter performs transmission to the another user terminal operated by the another user who has made a use reservation of the moving object.

5. The moving object utilization system according to claim 3, wherein the server device includes a use reservation stopper that stops the use reservation of the moving object when the one user uses the moving object and the information acquired by the device satisfies a predetermined condition.

6. The moving object utilization system according to claim 3, wherein the another user terminal operated by the another user includes a moving object displayer that displays the moving object in a mode in which the moving object can be understood as satisfying a predetermined condition when the one user uses the moving object and the information acquired by the device satisfies the predetermined condition.

7. A moving object utilization method executed in a moving object utilization system including a plurality of user terminals operated by a plurality of respective users and a server device capable of establishing communication connection with the user terminals, the moving object utilization system providing a service for the plurality of users to use a moving object in turn, the moving object utilization method comprising:
transmitting, by the server device, user information on one user who is using or has used the moving object and/or using state information on a using state of the moving object to another user terminal operated by another user different from the one user.

8. (canceled)

9. A user terminal in a moving object utilization system including: a plurality of user terminals operated by a plurality of respective users; and a server device capable of establishing communication connection with the user terminals, the moving object utilization system providing a service for the plurality of users to use a moving object in turn,
wherein the user terminal includes an information displayer that displays user information on another user who is using the moving object or has used the moving object and/or using state information on a using state of the moving object.

10. The moving object utilization system according to claim 1, wherein the server device includes a determiner that determines whether or not the user information on the one user who is using the moving object or who has used the moving object and/or the using state information on the using state of the moving object satisfy a predetermined condition for transmission to the another user terminal operated by the another user different from the one user.

11. (canceled)

12. The moving object utilization method according to claim 7 comprising determining, by the server device, whether or not the user information on the one user who is using the moving object or who has used the moving object and/or the using state information on the using state of the moving object satisfy a predetermined condition for transmission to the another user terminal operated by the another user different from the one user.
